(19) United States
(12) Patent Application Publication
(10) Pub. No.: US 2016/0196246 A1
(43) Pub. Date: Jul. 7, 2016

(54) PRESENTING WEB RESOURCE TO USER IN BROWSER

(71) Applicant: YANDEX EUROPE AG, Luzern (CH)

(72) Inventor: Victor Vladimirovich KARPOV, Moscow (RU)

(21) Appl. No.: 14/917,034

(22) PCT Filed: Dec. 1, 2014
(86) PCT No.: PCT/IB2014/066488

§ 371 Date: Mar. 7, 2016

(30) Foreign Application Priority Data
May 29, 2014 (RU) 2014122128

(51) Int. Cl. G06F 17/22; H04L 29/08

(52) U.S. Cl. CPC G06F 17/2288; H04L 67/02; G06F 17/2247; G06F 17/2205; G06F 17/2211

(57) ABSTRACT

An apparatus for and method of presenting a web resource to a user using a browser of an electronic device, the method executable at the electronic device, the method comprising: storing in a local memory a static component associated with the web resource, the static component for rendering a static portion of the web resource in the browser; establishing a permanent connection via a communication network with a server; receiving from the server via the permanent connection a dynamic component for the web resource, the dynamic component for rendering a dynamic portion of the web resource in the browser; combining the static component and the dynamic component to render the web resource in the browser; displaying to the user the web resource in the browser.

### CROSS-REFERENCE

The present application claims convention priority to Russian Patent Application No. 2014122128, filed May 29, 2014, entitled “SYSTEM FOR AND METHOD OF PRESENTING A WEB RESOURCE TO A USER USING A BROWSER” which is incorporated by reference herein in its entirety.

### FIELD

The present technology relates to browser side creation of web sites.

### BACKGROUND

This application generally relates to data processing and to computers and, more particularly, to system for and method of presenting a web resource to a user using a browser.

Typically, when a user wants to browse the Internet to visit webpage of a web site and the like, the user typically uses a web browser. Conventional methods for generation of a webpage by the browser are not always efficient. When a user visits a web site, the web browser usually downloads data from the web site in order to render the web page on the electronic device associated with the user. When the user visits the web page again later on, the web browser either retrieves the stored version of the web page from local cache or the web browser must request the data and refresh. If the content of the web page has been changed (as is typically the case with news portals, blogs and a plethora of other types of web pages), the web browser must download the whole web page. With the web sites that update content frequently (such as the case with previously mentioned fast content web pages), the web browser must constantly re-request all the data from the web server associated with the web site. These repeated requests to the web server and repeated transfer of data can cause delays with rendering a web page to the user and/or take their toll on the data bandwidth of the user connection to the network.

As should now become apparent, these conventional methods are especially unsuited for web pages being frequently visited and frequently updated. For example, social network web pages, web e-mail interfaces, main pages of search engine providers, news sites, on-line stores, airport and railway stations web sites, and so on. Within these web sites, both constant and the frequently-updated content of the web pages is updated by the web browser—hence, the web browser requests and the web server transmits the content of the entirety of the web page. The excessive traffic of data causes delays with rendering web pages to users and raises cost of web surfing.

### SUMMARY

Embodiments of the present technology have been developed based on inventors' appreciation of at least one problem associated with the prior art. Inventors have appreciated that there is a need for improved methods, systems, devices, and products for dynamically updating web content. Inventors have appreciated that when web content is updated, the web browser should not be required to reload all static and dynamic portions of a given web page that has been updated. Inventors' new approach to updating web pages may lead to reduced processing requirement for a web server associated with the given web page, reduced network traffic, and reduced cost of hardware equipment.

It is an object of the present technology to ameliorate at least some of the inconveniences present in the prior art.

In one aspect, implementations of the present technology provide a method of presenting a web resource to a user using a browser of an electronic device, the method executable at the electronic device, the method comprising: storing in a local memory a static component associated with the web resource, the static component for rendering a static portion of the web resource in the browser; establishing a permanent connection via a communication network with a server; receiving from the server via the permanent connection a dynamic component for the web resource, the dynamic component for rendering a dynamic portion of the web resource in the browser; combining the static component and the dynamic component to render the web resource in the browser; displaying to the user the web resource in the browser.

In some implementations, the server being a first server, the method further comprising, prior to the storing in a local memory the static component associated with the web resource, receiving the static component from a second server.

In some implementations, the first server and the second server are executed in a single server.

In some implementations, the receiving the static component is executed at a first download of the web resource to the electronic device.

In some implementations, the receiving the dynamic component is executed during the first download of the web resource.

In some implementations, the method further comprises determining a staleness state of the static component.

In some implementations, determining the staleness state of the static component comprises: sending a query to the server that requests a latest date and time stamp associated with the static component; receiving, from the server, the latest date and time stamp in response to the query, the latest date and time stamp indicating a most recent version of the static component of the web resource; comparing the latest date and time stamp of the first version of the static component and a current version of the static component.

In some implementations, the method further comprises, responsive to the latest date and time stamp of the first version of the static component not matching the date and time stamp of the current static component, receiving a second static component representative of the most recent version of the static component of the web resource.

In some implementations, the method further comprises replacing the first version of the static component with the second version of the static component to display an updated version of the web resource in the browser.

In some implementations, the method further comprises determining the staleness state of the dynamic component.

In some implementations, the determining the staleness state of the first version of the dynamic component comprises: sending a query to the second server that requests a latest date and time stamp associated with the static component; receiving, from the second server, the latest date and time stamp in response to the query, the latest date and time stamp indicating a most recent version of the static component of the web resource; comparing the latest date and time stamp of the first version of the dynamic component and a current version of the dynamic component.

In some implementations, the method further comprises, responsive to the latest date and time stamp of the first version of the dynamic component not matching the date and time stamp of the most recent version of the dynamic component of the web resource, receiving the most recent version of the dynamic component of the web resource, the most recent version of the dynamic component of the web resource being a second dynamic component.

In some implementations, determining the staleness state of the first version of the dynamic component is effected on the server side, and receiving the most recent version of the dynamic component of the web resource, the most recent version of the dynamic component of the web resource being a second dynamic component, is effected without the electronic device requesting the server for the most recent version of the dynamic component of the web resource. Put in other words, the second dynamic component can be received from the server without request of the electronic device as a push message sent by the server.

In some implementations, the method further comprises replacing the first version of the dynamic component with the second version of the dynamic component to display an updated version of the web resource in the browser on a periodic basis.

In some implementations, at least one of the static component and the dynamic component are coded in a respective native machine language.

In some implementations, the method further comprises translating of at least one of the static component and the dynamic component from the respective native machine language into an HTML code.

In some implementations, the translating is executed locally on the electronic device.

In some implementations, the permanent connection supports transmission of data through at least two communication channels.

In some implementations, the permanent connection, the permanent connection supporting transmission of data through at least two communication channels, enables transmission of data using at least two data transfer protocols comprising HTTP-protocol and WebSocket protocol.

In some implementations, a last version of the static component being a version of the static component having the most recent date and time stamp, a last version of the dynamic component being a version of the dynamic component having the most recent date and time stamp, the method further comprises combining the last version of the static component and the last version of the dynamic component to render the web resource in the browser on a periodic basis.

In another aspect, implementations of the present technology provide an electronic device. The electronic device comprises a display screen. The electronic device further comprises a computer usable information storage medium. The electronic device further comprises a processor being configured to have access to computer readable commands which commands, when executed, cause the processor to: store in a local memory a static component associated with the web resource, the static component for rendering a static portion of the web resource in the browser; establish a permanent connection via a communication network with a server; receive from the server via the permanent connection a dynamic component for the web resource, the dynamic component for rendering a dynamic portion of the web resource in the browser; combine the static component and the dynamic component to render the web resource in the browser; display to the user the web resource in the browser.

In some implementations, the server being a first server, computer readable commands, when executed, further cause the processor, prior to the storing in a local memory the static component associated with the web resource, to receive the static component from a second server.

In some implementations, the first server and the second server are executed in a single server.

In some implementations, the receiving the static component is executed at a first download of the web resource to the electronic device.

In some implementations, the receiving the dynamic component is executed during the first download of the web resource.

In some implementations, computer readable commands, when executed, further cause the processor to determine a staleness state of the static component.

In some implementations, the determining the staleness state of the static component comprises: sending a query to the server that requests a latest date and time stamp associated with the static component; receiving, from the server, the latest date and time stamp in response to the query, the latest date and time stamp indicating a most recent version of the static component of the web resource; comparing the latest date and time stamp of the first version of the static component and a current version of the static component.

In some implementations, computer readable commands, when executed, further cause the processor, responsive to the latest date and time stamp of the first version of the static component not matching the date and time stamp of the current static component, to receive a second static component representative of the most recent version of the static component of the web resource.

In some implementations, computer readable commands, when executed, further cause the processor to replace the first version of the static component with the second version of the static component to display an updated version of the web resource in the browser.

In some implementations, computer readable commands, when executed, further cause the processor to determine the staleness state of the dynamic component.

In some implementations, the determining the staleness state of the first version of the dynamic component comprises: sending a query to the second server that requests a latest date and time stamp associated with the static component; receiving, from the second server, the latest date and time stamp in response to the query, the latest date and time stamp indicating a most recent version of the static component of the web resource; comparing the latest date and time stamp of the first version of the dynamic component and a current version of the dynamic component.

In some implementations, computer readable commands, when executed, further cause the processor, responsive to the latest date and time stamp of the first version of the dynamic component not matching the date and time stamp of the most recent version of the dynamic component of the web resource, to receive the most recent version of the dynamic component of the web resource, the most recent version of the dynamic component of the web resource being a second dynamic component.

In some implementations, wherein the staleness state of the first version of the dynamic component is effected on the server side, and wherein the most recent version of the dynamic component of the web resource, the most recent version of the dynamic component of the web resource being a second dynamic component, is received by the electronic device without the electronic device requesting the server for the most recent version of the dynamic component of the web resource. Put in other words, the second dynamic component can be received from the server without request of the electronic device as a push message sent by the server.

In some implementations, computer readable commands, when executed, further cause the processor to replace the first version of the dynamic component with the second version of the dynamic component to display an updated version of the web resource in the browser on a periodic basis.

In some implementations, at least one of the static component and the dynamic component are coded in a respective native machine language.

In some implementations, computer readable commands, when executed, further cause the processor to translate of at least one of the static component and the dynamic component from the respective native machine language into an HTML code.

In some implementations, the translating is executed locally on the electronic device.

In some implementations, the permanent connection supports transmission of data through at least two communication channels.

In some implementations, the permanent connection, the permanent connection supporting transmission of data through at least two communication channels, enables transmission of data using at least two data transfer protocols comprising HTTP-protocol and WebSocket protocol.

In some implementations, a last version of the static component being a version of the static component having the most recent date and time stamp, a last version of the dynamic component being a version of the dynamic component having the most recent date and time stamp, wherein computer readable commands, when executed, further cause the processor to combine the last version of the static component and the last version of the dynamic component to render the web resource in the browser on a periodic basis.

In the context of the present specification, unless provided for specifically otherwise, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless provided for specifically otherwise, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein.

In the context of the present specification, unless provided for specifically otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless provided for specifically otherwise, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, unless provided for specifically otherwise, the expression “component” is meant to include software (appropriate to a particular hardware context) that is both necessary and sufficient to achieve the specific function(s) being referenced.

In the context of the present specification, unless provided for specifically otherwise, the expression “computer usable information storage medium”, or “local memory, is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless provided for specifically otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, unless provided for specifically otherwise, the expression “web browser”, or “browser”, means any software program which can display text, graphics, or both, from Web pages on Web sites. Examples of a Web browser include without limitation Yandex™ browser, Mozilla Firefox™, Microsoft Internet Explorer™.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system 100, the system 100 being implemented in accordance with non-limiting embodiments of the present technology.

FIG. 2 is a schematic diagram depicting a system 200, the system 200 being implemented in accordance with other non-limiting embodiments of the present technology.

FIG. 3 is a block diagram depicting a method 300, the method 300 being implemented within the system 200 of FIG. 2 and being implemented according with non-limiting embodiments of the present technology.

FIG. 4 is a block diagram depicting a method 400, the method 400 being implemented within the system 100 of FIG. 1 and being implemented according with other non-limiting embodiments of the present technology.

FIG. 5 is a block diagram depicting a method 500, the method 500 being implemented within the system 100 of FIG. 1 and being implemented according with yet another non-limiting embodiment of the present technology.

### DETAILED DESCRIPTION

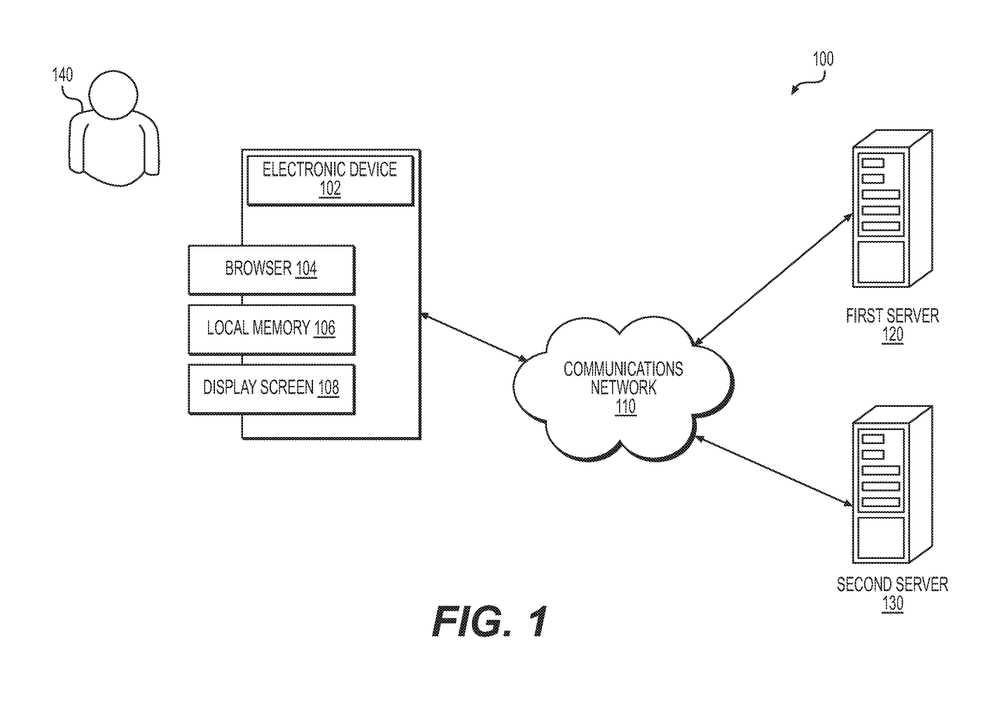

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user 140 and, as such, can sometimes be referred to as a “client device”. It should be noted that the fact that the electronic device 102 is associated with the user does not need to suggest or imply any mode of operation—such as a need to log in, a need to be registered or the like.

The implementation of the electronic device 102 is not particularly limited, but as an example, the electronic device 102 may be implemented as a personal computer (desktops, laptops, netbooks, etc.) or as a wireless communication device (a smartphone, a tablet and the like). The electronic device 102 comprises hardware and/or software and/or firmware (or a combination thereof), as is known in the art, to execute a web browser 104, also sometimes referred to herein below as a browser 104.

Generally speaking, the purpose of the web browser 104 is to enable the user 140 to access and to preview various web resources. The web browser 104 can receive a web resource which can be a web site, a web page, a portion of the web page, as is known in the art. According to embodiments of the present technology, the web browser 104 is also configured to receive: (i) a static component associated with the web resource for rendering a static portion of the web resource in the browser 104, and (ii) a dynamic component associated with the web resource for rendering a dynamic portion of the web resource in the browser 104. Naturally, the web browser 104 can be configured to additionally receive other web content. The static component associated with the web resource and the dynamic component associated with the web resource can be encoded in machine language. In some embodiments, the static component and the dynamic component can be encoded in their native machine languages, which do not have to be but can be the same native machine language. In other embodiments, the static component and the dynamic component can be encoded in HTML. In other embodiments, one or both of the static component and the dynamic component can be encoded in XML or JSON.

The web browser 104 can combine the static component and the dynamic component to render and to display the web resource to the user 140 (using the output device of the electronic device 102, such as a touch screen or the like). When one or both the static component associated with the web resource and the dynamic component associated with the web resource are executed in native machine language, the web browser 104 can translate them from the respective native machine language into an HTML code, and render the web resource to the user 140 using the so-generated HTML code.

In some embodiments of the present technology, the web browser 104 can also determine a staleness state of the dynamic component and/or a staleness state of the static component. The web browser 104 can periodically update the dynamic component associated with the web resource and replace a stale version of the dynamic component in the web resource with a new version of the dynamic component, to render an updated web resource to the user 140.

The web browser 104 can additionally or alternatively periodically update the static component associated with the web resource and replace a stale version of the static component in the web resource with a new version of the dynamic component, and render an updated web resource to the user 140. The web browser 104 can periodically update both the static component and the dynamic component associated with the web resource and replace the stale version of both the static component and the dynamic component with new versions of the static component and the dynamic component, and render updated web resource to the user 140.

Within embodiments of the present technology, the web browser 104 is configured to store the static component in a local memory 106 of the electronic device 102. In some embodiments, the web browser 104 can be pre-programmed with the static component. In other embodiments, the web browser 104 can download and store an indication of the static component when the user 140 accesses a given web site for the first time.

According to implementations of the present technology, the web browser 104 can establish and maintain a permanent connection with a server (as will be described in greater detail herein below), which permanent connection supports transmission of data through at least two communication channels. The permanent connection can enable transmission of data using at least two data transfer protocols comprising HTTP-protocol and WebSocket protocol.

The web browser 104 can be any conventional web browser. As non-limiting examples, the web browser 104 can be implemented as Yandex™ browser application, Mozilla Firefox™ browser application, Microsoft Internet Explorer™ browser application. It should be expressly understood that any other commercially available or proprietary browser application can be used for implementing non-limiting embodiments of the present technology.

The electronic device 102 further comprises a computer usable information storage medium, also referred to as the aforementioned local memory 106. Local memory 106 can comprise any type of media, including but not limited to RAM, ROM, disks (CD-ROMs, DVDs, floppy disks, hard drivers, etc.), USB keys, solid state-drives, tape drives, etc. Generally speaking, the purpose of the local memory 106 is to store computer readable commands as well as any other data, such as user files, cached files, etc. The local memory 106 can store web resources or components of web resources. Components of web resources stored in a local memory 106 can be static components of web resources and dynamic components of web resources.

The electronic device 102 further comprises a display screen 108. Display screen 108 can be liquid crystal display (LCD), light emitting diode (LED), Interferometric modulator display (IMOD), or any other suitable display technology. The display screen 108 is generally configured to display a graphical user interface (GUI) that provides an easy to use visual interface between the user 140 of the electronic device 102 and the operating system or application(s) running on the electronic device 102. Generally, the GUI presents programs, files and operational options with graphical images. Display screen 108 is also generally configured to display other information like user data and web resources. Display screen 108 can also be touch based devices such as touchpad and touch screen. A touchpad is an input device including a surface that detects touch-based inputs of users. Similarly, a touch screen is a display that detects the presence and location of user touch inputs. Display screen 108 can also include dual touch or multi-touch displays or touchpads that can identify the presence, location and movement of a touch inputs.

The electronic device 102 is coupled to a communications network 110 via a communication link (not separately numbered). In some non-limiting embodiments of the present technology, the communications network 110 can be implemented as the Internet. In other embodiments of the present technology, the communications network 110 can be implemented differently, such as any wide-area communications network, local-area communications network, a private communications network and the like.

How the communication link is implemented is not particularly limited and will depend on how the electronic device 102 is implemented. Merely as an example and not as a limitation, in those embodiments of the present technology where the electronic device 102 is implemented as a wireless communication device (such as a smartphone), the communication link can be implemented as a wireless communication link (such as but not limited to, a 3G communications network link, a 4G communications network link, a Wireless Fidelity, or WiFi® for short, Bluetooth® and the like). In those examples, where the electronic device 102 is implemented as a notebook computer, the communication link can be either wireless (such as the Wireless Fidelity, or WiFi® for short, Bluetooth® or the like) or wired (such as an Ethernet based connection).

It should be expressly understood that implementations for the electronic device 102, the communication link and the communications network 110 are provided for illustration purposes only. As such, those skilled in the art will easily appreciate other specific implementation details for the electronic device 102, the communication link and the communications network 110. As such, by no means, examples provided herein above are meant to limit the scope of the present technology.

The electronic device 102 can establish connections, through the communication network 110, with other devices, such as servers. According to embodiments of the present technology, the connection established through the communication network 110 can be a permanent connection supporting transmission of data through at least two communication channels. Permanent connections can enable transmission of data using at least two data transfer protocols comprising HTTP-protocol and WebSocket protocol.

Also coupled to the communications network 110 is a first server 120. The first server 120 can be implemented as a conventional computer server. In an example of an embodiment of the present technology, the first server 120 can be implemented as a Dell™ PowerEdge™ Server running the Microsoft™ Windows Server™ operating system. Needless to say, the first server 120 can be implemented in any other suitable hardware and/or software and/or firmware or a combination thereof. Generally speaking, the purpose of the first server 120 is to enable the user 140 to receive and to preview web resources. The first server 120 can store information about one or more web resources and to transmit such information to the electronic device 102 via the communications network 110 to enable the electronic device 102 to render and display the web resource to the user 140. The first server 120 can store the information about one or more resources locally or to retrieve such information from external devices. Web resource can be a web site, a web page, a portion of the web page.

According to embodiments of the present technology, the first server 120 is also configured to create, store and transmit to the electronic device 102 a static component associated with the web resource for rendering a static portion of the web resource in the browser.

Also coupled to the communications network 110 is a second server 130. The second server 130 can also be implemented as a conventional computer server. In an example of an embodiment of the present technology, the second server 130 can be implemented as a Dell™ PowerEdge™ Server running the Microsoft™ Windows Server™ operating system. Needless to say, the second server 130 can be implemented in any other suitable hardware and/or software and/or firmware or a combination thereof.

Generally speaking, the purpose of the second server 130 is to enable the user 140 to receive and to preview web resources. The second server 130 can store information about one or more web resources and to transmit such information to the electronic device 102 via the communications network 110 to enable the electronic device 102 to render and display the web resource to the user 140. The second server 130 can store the information about one or more resources locally or to retrieve such information from external devices. Web resource can be a web site, a web page, a portion of the web page.

According to embodiments of the present technology, the second server 130 is configured to create, store and transmit to the electronic device 102 a dynamic component associated with the web resource for rendering a dynamic portion of the web resource in the browser, and other web content.

The second server 130 can establish and maintain a permanent connection which supports transmission of data through at least two communication channels. The permanent connection can enable transmission of data using at least two data transfer protocols comprising HTTP-protocol and WebSocket protocol. Within embodiments of the present technology, the transmission of the dynamic component by the second server 130 towards the electronic device 102 is executed via the permanent connection.

In the depicted non-limiting embodiment of present technology, the first server 120 and the second server 130 are implemented as two distinct servers. As has been described above and by means of a generalization, when the first server 120 and the second server 130 are implemented as two distinct servers, at least one of the first server 120 and the second server 130 is configured to establish and maintain a permanent connection which supports transmission of data through at least two communication channels. Within these embodiments, the at least one of the first server 120 and the second server 130 is configured to maintain and to transmit, via such permanent connection, to the electronic device 102 the dynamic component, while the other one of the at least one of the first server 120 and the second server 130 is configured to maintain and to transmit to the electronic device 102 the static component. Naturally, it is possible that bother the first server 120 and the second server 130 are both configured for maintaining and transmission of the static component and the dynamic component and, therefore, can operate in a redundancy mode.

In another alternative non-limiting embodiment of the present technology, the functionality of one or both of the first server 120 and the second server 130 may be distributed and may be implemented via multiple servers. When the functionality of either one or both of the first server 120 and the second server 130 is distributed and is implemented via multiple servers, at least one server of those distributed servers has to be able to establish and maintain a permanent connection which supports transmission of data through at least two communication channels.

In alternative non-limiting embodiments of the present technology, the first server 120 and the second server 130 can be implemented as a single server which can implement the functionality of both the first server 120 and the second server 130.

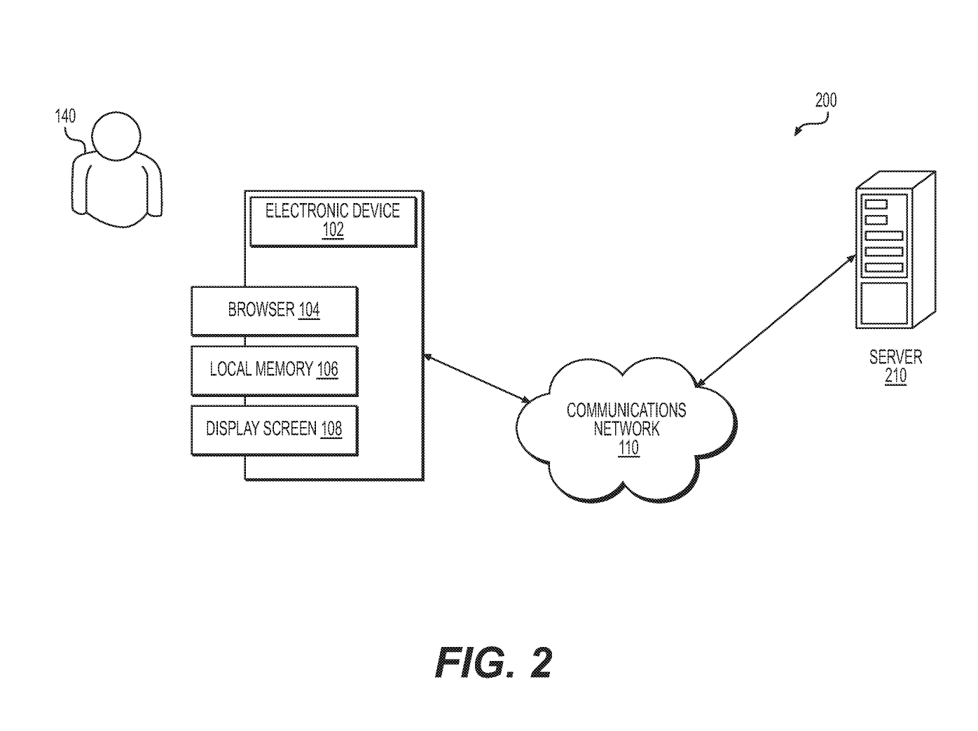

Referring to FIG. 2, there is shown a schematic diagram of a system 200 being alternative embodiment of the present technology. The system 200 is implemented substantially similar to the system 100 of FIG. 1, other than for the specific differences described herein below. As such, the description of FIG. 1 will apply mutatis mutandis to the system 200. The system 200 depicts an alternative non-limiting embodiment of the present technology, where the first server 120 and the second server 130 of FIG. 1 are implemented as a single server 210 which can implement the functionality of both the first server 120 and the second server 130.

Therefore, in accordance with this alternative non-limiting embodiment of the present technology, the single server 210 is configured to enable the user 140 to receive and to preview web resources. The single server 210 can store information about one or more web resources and to transmit such information to the electronic device 102 via the communications network 110 to enable the electronic device 120 to render and display the web resource to the user 140.

The single server 210 can store the information about one or more resources locally or to retrieve such information from external devices. Web resource can be a web site, a web page, a portion of the web page. According to embodiments of the present technology, the single server 210 is also configured to create, for some or all web resources that it stores, (i) a static component and (ii) a dynamic component. More specifically, the single server 210 can store and transmit to the electronic device 102: (i) a static component associated with the web resource for rendering a static portion of the web resource in the browser and (ii) a dynamic component associated with the web resource for rendering a dynamic portion of the web resource in the browser. Naturally, the single server 210 can be further configured to update, from time to time, the dynamic component and to transmit such the updated component to the electronic device 102.

Given the architecture of either FIG. 1 or FIG. 2, it is possible to execute a method of presenting a web resource to a user 140 using a web browser 104 of the electronic device 102. The method can be conveniently executed at the electronic device 102. The electronic device 102, as has been discussed above, can execute the web browser 104.

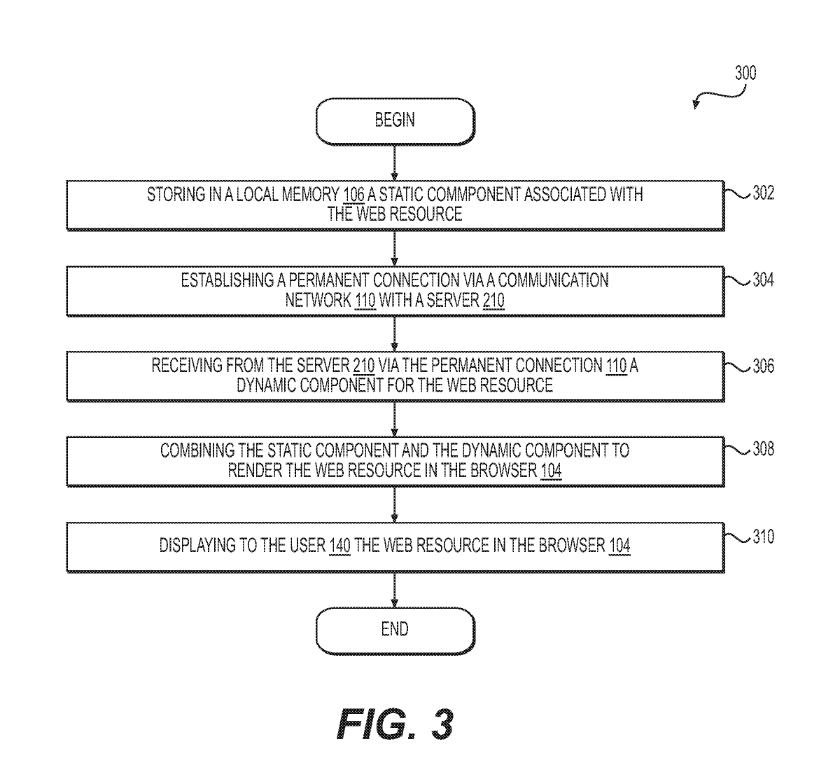

Referring to FIG. 3, there is shown a block diagram depicting a method 300, the method 300 being implemented within the electronic device 102 of the system 200 of FIG. 2 and being implemented according with non-limiting embodiments of the present technology.

The method 300 starts at step 302, where the electronic device 102 stores in a local memory 106 a static component associated with the web resource. The static component is for rendering a static portion of the web resource in the web browser 104.

In some implementations of the method 300, the static component is encoded in a native machine language. Where the static component is encoded in the native machine language, as part of step 302, the electronic device 102 is further configured to translate the static component from the native machine language into another language, such as HTML and the like.

In some implementations of the method 300, the static component is encoded in a HTML language.

The method 300 then proceeds to step 304.

Next, at step 304, the web browser 104 establishes a permanent connection via the communication network 110 with the single server 210. The established permanent connection supports transmission of data through at least two communication channels. The permanent connection enables transmission of data using at least two data transfer protocols comprising HTTP-protocol and WebSocket protocol. In some embodiments, the permanent connection is maintained during substantially the whole session of the web browser 104.

The method 300 then proceeds to step 306.

Next, at step 306, the web browser 104 receives from the single server 210 via the permanent connection a dynamic component for the web resource, the dynamic component for rendering a dynamic portion of the web resource in the browser 104.

In some implementations of the method 300, the dynamic component is encoded in a native machine language. Where the dynamic component is encoded in the native machine language, as part of step 302, the electronic device 102 is further configured to translate the dynamic component from the native machine language into another language, such as HTML and the like.

In some implementations of the method 300, the dynamic component is encoded in a HTML language.

The method 300 then proceeds to step 308.

Next, at step 308, the web browser 104, combines the static component and the dynamic component to render the web resource in the web browser 104.

The method 300 then proceeds to step 310.

Next, at step 310, the electronic device displays to the user 140 the web resource in the web browser 104.

In some embodiments of the present technology, the method 300 then reverts back to step 306, where the electronic device 102 receives an updated dynamic component, as will be described in greater detail herein below. Alternatively, the method 300 can then terminate.

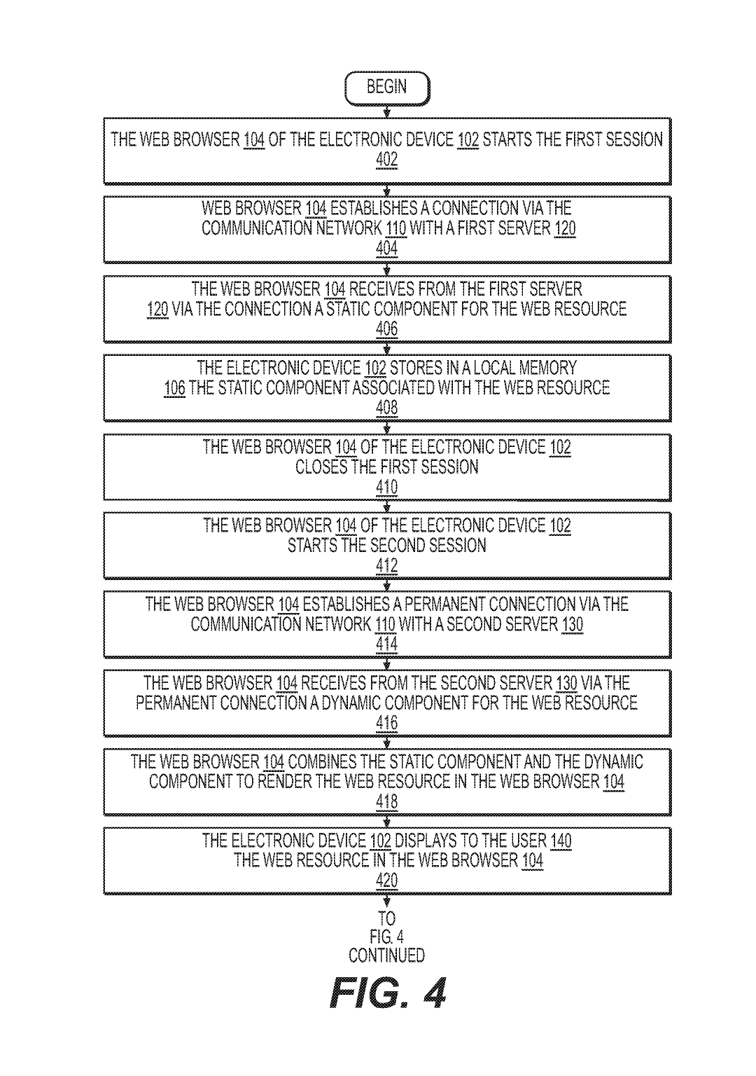

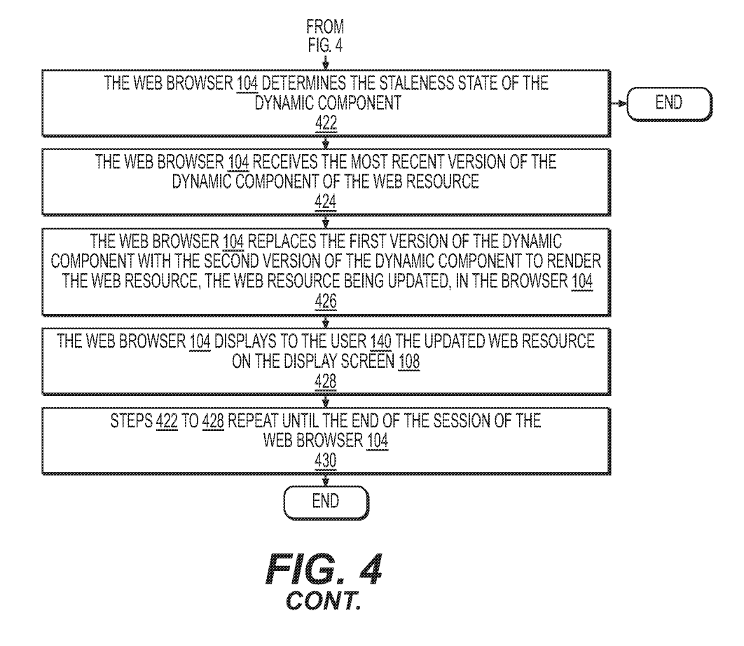

Referring to the FIG. 4, there is shown a block diagram depicting a method 400, the method 400 being implemented within the system 100 of FIG. 1 and being implemented according with non-limiting embodiments of the present technology.

The method 400 is implemented in accordance with non-limiting embodiments of the present technology. During the execution of the method 400, the web browser 104 of the electronic device 102 executes at least two browsing sessions of the web browser 104, at least two sessions consecutive in time—a first session executed at a first point in time and a second session executed at a second point in time, after the first point in time.

During the first session, the web browser 104 receives from the single server 210, a web resource and stores in the local memory 106 a static component for rendering a static portion of the web resource in the local memory 106. During the second session, the web browser 104 receives, from the single server 210 via a permanent connection, a dynamic component for rendering a dynamic portion of the web resource in the browser 104, and combines the static component and the dynamic component to render the web resource in the web browser 104. The web browser 104 displays the so-combined web resource to the user 140 on the display screen 108.

The web browser 104 can also periodically determine the staleness state of the dynamic component. When the dynamic component is deemed to be stale, the web browser 104 requests from the single server 210 and, responsive to the request, receives from the second server 130 via a permanent connection a new version of the dynamic component. The web browser 104 then combines the static component and the new version of the dynamic component to render the updated web resource in the web browser 104. The web browser 104 displays the updated web resource to the user 140 on the display screen 108.

More specifically, the method 400 starts at step 402, where the web browser 104 of the electronic device 102 starts the first session.

Next, at step 404, the web browser 104 establishes a connection via the communication network 110 with a first server 120. The connection supports transmission of data through a communication channel. It should be noted that the connection established in step 404 is not necessarily (but can be) a permanent connection.

Next, at step 406, the web browser 104 receives from the first server 120 via the connection a static component for the web resource, the static component for rendering a static portion of the web resource in the browser 104. In some embodiments, the web browser 104 also can receive from the first server 120 via the connection a dynamic component for the web resource, the dynamic component for rendering a dynamic portion of the web resource in the browser 104.

Next, at step 408, the electronic device 102 stores in a local memory 106 the static component associated with the web resource, the static component for rendering a static portion of the web resource in the browser 104.

In some implementations of the method 400, the static component is encoded in a native machine language. Where the static component is encoded in the native machine language, as part of step 408, the electronic device 102 is further configured to translate the static component from the native machine language into another language, such as HTML and the like. Naturally, in other embodiments of the present technology, the translation of the native machine language into another suitable format/encoding can be executed at other stages of the method 400. For example, the electronic device 102 can store the static component in the native machine language and, at a later point in time (for example, when the user 140 requests the web resource), execute the translation.

In some implementations of the method 300, the static component is encoded in a HTML language.

Next, at step 410, the web browser 104 of the electronic device 102 terminates the first session.

As a person skilled in the art will appreciate, the static component associated with the web resource will be stored in the local memory 106 even after the session of the web browser 104 is terminated.

Next, at step 412, the web browser 104 of the electronic device 102 starts a second session.

Next, at step 414, the web browser 104 establishes a permanent connection via the communication network 110 with a second server 130. The established permanent connection supports transmission of data through at least two communication channels. The permanent connection enables transmission of data using at least two data transfer protocols comprising HTTP-protocol and WebSocket protocol. In some embodiments, the permanent connection is maintained during substantially the whole session of the web browser 104.

Next, at step 416, the web browser 104 receives from the second server 130 via the permanent connection a dynamic component for the web resource, the dynamic component for rendering a dynamic portion of the web resource in the browser 104.

In some implementations of the method 400, the dynamic component is encoded in a native machine language. Where the dynamic component is encoded in the native machine language the electronic device 102 is further configured to translate the dynamic component from the native machine language into another language, such as HTML and the like.

In some implementations of the method 400, the dynamic component is encoded in a HTML language.

The method 400 then proceeds to step 418.

Next, at step 418, the web browser 104 combines the static component and the dynamic component to render the web resource in the web browser 104.

Next, at step 420, the electronic device 102 displays to the user 140 the web resource in the web browser 104.

The method 400 then proceeds to step 422.

Next, at step 422, the web browser 104 determines the staleness state of the dynamic component. To determine the staleness state of the dynamic component, the web browser 104 sends a query to the second server 130 requesting a latest date and time stamp associated with the static component of the web resource. Then, in response to the query, the web browser 104 receives from the second server 130 the latest date and time stamp indicating a most recent version of the static component of the web resource. Thereafter, the web browser 104 compares the latest date and time stamp of the first version of the dynamic component and a current version of the dynamic component.

When the latest date and time stamp of the first version of the dynamic component received at step 416 matches the date and time stamp of the current version of the dynamic component, the first version of the dynamic component received at step 416 is not stale. In such a case, the web browser 104 continues periodically determining the staleness state of the dynamic component, as it is described at step 422, until occurrence of one of: either the end of the session of the web browser 104, or till the latest date and time stamp of the first version of the dynamic component received at step 416 does not match the date and time stamp of the current version of the dynamic component, what arrives first.

If the end of the session of the web browser 104 occurs first, the method 400 then terminates.

If the web browser 104, before the end of the session of the web browser 104, determines that the latest date and time stamp of the first version of the dynamic component received at step 416 does not match the date and time stamp of the current version of the dynamic component, the method 400 then proceeds to step 424.

When the latest date and time stamp of the first version of the dynamic component received at step 416 does not match the date and time stamp of the current version of the dynamic component, the first version of the dynamic component received at step 416 is deemed to be stale. In such a case, at step 424, the web browser 104 requests and receives the most recent version of the dynamic component of the web resource, the most recent version of the dynamic component of the web resource being a second dynamic component. In alternative implementations, the web browser 104 receives the most recent version of the dynamic component of the web resource, the most recent version of the dynamic component of the web resource being a second dynamic component, without the web browser 104 transmitting a request to the server. In these implementations, the staleness state of the dynamic component can be established on the server side.

In the context of the present specification, unless provided for specifically otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “second dynamic component” is not intended to imply any particular type, hierarchy or ranking (for example) of/between dynamic components, nor is their use (by itself) intended imply that any “second dynamic component” must necessarily exist in any given situation. Further, reference to a “second dynamic component” does not imply that the “second dynamic component” was preceded by only one first dynamic component. It is possible that the “second dynamic element” was preceded by the “first dynamic element”, the “zero dynamic element”, and so on. Usage of the words “first”, “second”, “third” and so on does not necessarily mean that there were accordingly no preceding elements, one preceding element, two preceding elements, and so on.

Next, at step 426, the web browser 104 replaces the first version of the dynamic component with the second version of the dynamic component to render an updated version of the web resource in the browser 104.

Next, at step 428, the web browser 104 displays to the user 140 the updated version of the web resource on the display screen 108.

Next, at step 430, steps 422 to 428 are repeated until the end of the second session of the web browser 104.

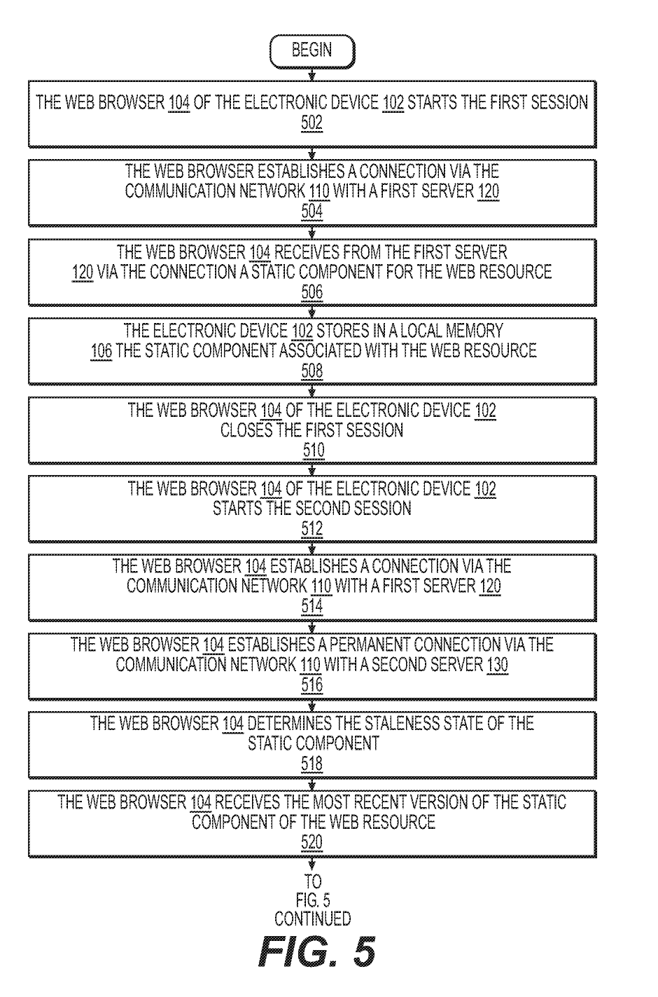

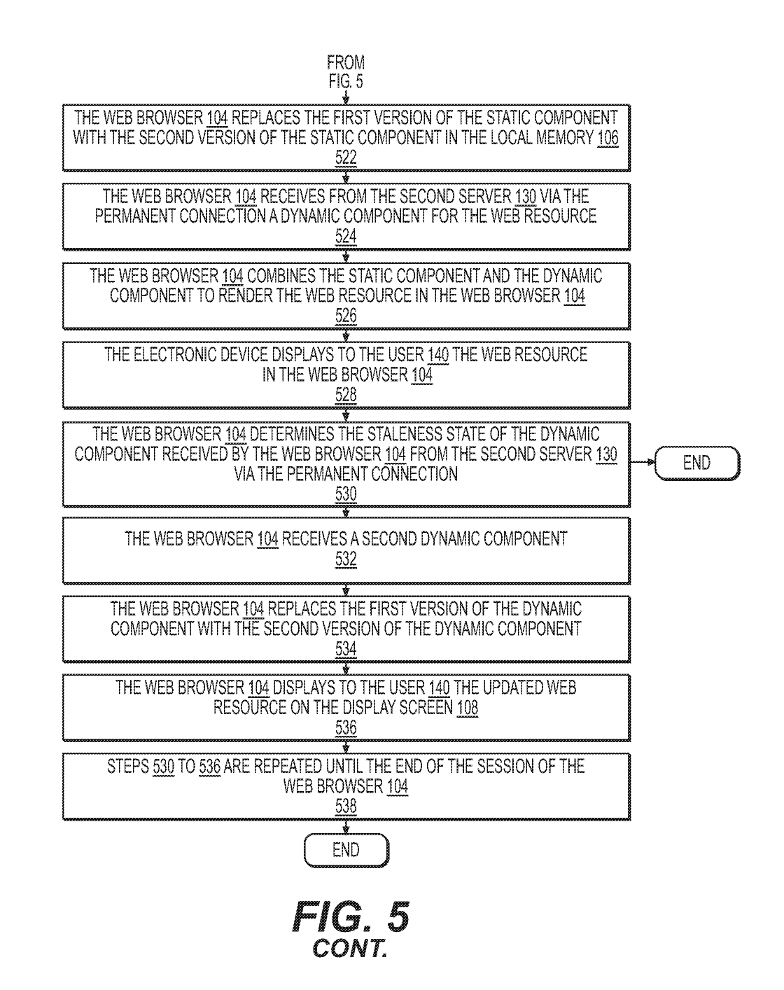

Referring to the FIG. 5, there is shown a block diagram depicting a method 500, the method 500 being implemented within the system 100 of FIG. 1 and being implemented according with other non-limiting embodiments of the present technology. The method 500 is substantially similar to the method 400. The main distinction, however, is that method 500, unlike the method 400, provides for updating both the static component for rendering a static portion of the web resource and the dynamic component for rendering a dynamic portion of the web resource.

The method 500 describes implementations of the present technology, where web browser 104 of the electronic device 102 executes at least two sessions of the web browser 104, at least two sessions consecutive in time. Basically, during the first session, the web browser 104 receives a web source and stores in the local memory 106 a static component for rendering a static portion of the web resource in the browser 104. Basically, during the second session, the web browser 104 updates the static component for rendering a static portion of the web resource in the browser 104 and receives a dynamic component for rendering a dynamic portion of the web resource in the browser 104. The web browser combines the dynamic component and the original or the most recent version of the static component to render the web resource in the web browser 104. The web browser 104 displays the web resource to the user 140 on the display screen 108. Then, the web browser 104 periodically determines the staleness state of the dynamic component. When the dynamic component is deemed to be stale, the web browser 104 receives a new version of the dynamic component, the web browser 104 combines the original or the most recent version of the static component and the new version of the dynamic component to render the updated web resource in the web browser 104. The web browser 104 displays then the updated web resource to the user 140 on the display screen 108. In more details, the method 500 is described below.

The method 500 starts at step 502, where the web browser 104 of the electronic device 102 starts the first session.

Next, at step 504, the web browser establishes a connection via the communication network 110 with a first server 120. The connection supports transmission of data through a communication channel. It should be noted that the connection is not necessarily (but can be) a permanent connection.

Next, at step 506, the web browser 104 receives from the first server 120 via the connection a static component for the web resource, the static component for rendering a static portion of the web resource in the browser 104. In some embodiments, the web browser 104 also can receive from the first server 120 via the connection a dynamic component for the web resource, the dynamic component for rendering a dynamic portion of the web resource in the browser 104.

Next, at step 508, the electronic device 102 stores in a local memory 106 the static component associated with the web resource, the static component for rendering a static portion of the web resource in the browser 104.

In some implementations of the method 500, the static component is encoded in a native machine language. Where the static component is encoded in the native machine language, the electronic device 102 is further configured to translate the static component from the native machine language into another language, such as HTML and the like.

In some implementations of the method 300, the static component is encoded in a HTML language.

Next, at step 510, the web browser 104 of the electronic device 102 closes the first session.

As a person skilled in the art will understand, the static component associated with the web resource will be stored in the local memory 106 even after the session of the web browser 104 is closed.

Next, at step 512, the web browser 104 of the electronic device 102 starts the second session.

Next, at step 514, the web browser 104 establishes a connection via the communication network 110 with a first server 120, the connection supporting transmission of data through a communication channel.

Also, at step 516, the web browser 104 establishes a permanent connection via the communication network 110 with a second server 130. The established permanent connection supports transmission of data through at least two communication channels. The permanent connection enables transmission of data using at least two data transfer protocols comprising HTTP-protocol and WebSocket protocol. In some embodiments, the permanent connection is maintained during substantially the whole session of the web browser 104.

Next, at step 518, the web browser 104 determines the staleness state of the static component. To determine the staleness state of the static component, the web browser 104 sends a query to the first server 120 requesting a latest date and time stamp associated with the static component of the web resource. Then, in response to the query, the web browser 104 receives from the first server 120 the latest date and time stamp indicating a most recent version of the static component of the web resource. Thereafter, the web browser 104 compares the latest date and time stamp of the first version of the static component and a current version of the static component.

When the latest date and time stamp of the first version of the static component received at step 506 matches the date and time stamp of the current version of the static component, the first version of the static component received at step 506 is not stale. In such a case, the web browser 104 uses the static component received at step 506 to render the web resource in the browser 104.

If the web browser 104 determines that the latest date and time stamp of the first version of the static component received at step 516 does not match the date and time stamp of the current version of the static component, the method 500 then proceeds to step 520.

When the latest date and time stamp of the first version of the static component received at step 506 does not match the date and time stamp of the current version of the static component, the first version of the static component received at step 506 is deemed to be stale. In such a case, at step 520, the web browser 104 receives the most recent version of the static component of the web resource, the most recent version of the static component of the web resource being a second static component.

In the context of the present specification, unless provided for specifically otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “second static component” is not intended to imply any particular order, type, chronology, hierarchy or ranking (for example) of/between static components, nor is their use (by itself) intended imply that any “second static component” must necessarily exist in any given situation. Further, reference to a “second static component” does not imply that the “second static component” was preceded by only one first static component. It is possible that the “second static element” was preceded by the “first static element”, or other prior “static elements”, and so on. Usage of the words “first”, “second”, “third” and so on does not necessarily mean that there were accordingly no preceding elements, one preceding element, two preceding elements, and so on.

Next, at step 522, the web browser 104 replaces the first version of the static component with the second version of the static component in the local memory 106.

The method 500 then proceeds to step 524.

Next, at step 524, the web browser 104 receives from the second server 130 via the permanent connection a dynamic component for the web resource, the dynamic component for rendering a dynamic portion of the web resource in the browser 104.

In some implementations of the method 500, the dynamic component is encoded in a native machine language. Where the dynamic component is encoded in the native machine language the electronic device 102 is further configured to translate the dynamic component from the native machine language into another language, such as HTML and the like.

In some implementations of the method 500, the dynamic component is encoded in a HTML language.

The method 500 then proceeds to step 526.

Next, at step 526, the web browser 104, combines the static component and the dynamic component to render the web resource in the web browser 104, the static component being the second static component stored in the local memory 106 at the step 522.

Next, at step 528, the electronic device displays to the user 140 the web resource in the web browser 104.

The method 500 then proceeds to step 530.

Next, at step 530, the web browser 104 determines the staleness state of the dynamic component received by the web browser 104 from the second server 130 via the permanent connection at step 522, the dynamic component for rendering a dynamic portion of the web resource in the browser 104. To determine the staleness state of the dynamic component, the web browser 104 sends a query to the second server 130 requesting a latest date and time stamp associated with the static component of the web resource. Then, in response to the query, the web browser 104 receives from the second server 130 the latest date and time stamp indicating a most recent version of the static component of the web resource. Thereafter, the web browser 104 compares the latest date and time stamp of the first version of the dynamic component and a current version of the dynamic component.

When the latest date and time stamp of the first version of the dynamic component received at step 524 matches the date and time stamp of the current version of the dynamic component, the first version of the dynamic component received at step 524 is not stale. In such a case, the web browser 104 continues periodically determining the staleness state of the dynamic component, as it is described at step 530, until occurrence one of: either the end of the session of the web browser 104, or till the latest date and time stamp of the first version of the dynamic component received at step 524 does not match the date and time stamp of the current version of the dynamic component, what arrives first.

If the end of the session of the web browser 104 occurs first, the method 500 then terminates.

If the web browser 104, before the end of the session of the web browser 104 determines that the latest date and time stamp of the first version of the dynamic component received at step 524 does not match the date and time stamp of the current version of the dynamic component, the method 500 then proceeds to step 532.

When the latest date and time stamp of the first version of the dynamic component received at step 524 does not match the date and time stamp of the current version of the dynamic component, the first version of the dynamic component received at step 524 is deemed to be stale. In such a case, at step 532, the web browser 104 receives the most recent version of the dynamic component of the web resource, the most recent version of the dynamic component of the web resource being a second dynamic component. In alternative implementations, the web browser 104 receives the most recent version of the dynamic component of the web resource, the most recent version of the dynamic component of the web resource being a second dynamic component, without the web browser 104 sending a request to the server. In these implementations, the staleness state of the dynamic component can be established on the server side.

Next, at step 534, the web browser 104 replaces the first version of the dynamic component with the second version of the dynamic component to render an updated version of the web resource in the browser 104.

Next, at step 536, the web browser 104 displays to the user 140 the web resource, the web resource being updated, on the display screen 108.

Next, at step 538, steps 530 to 536 are repeated until the end of the session of the web browser 104.

The method 500 then terminates.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of presenting a web resource to a user using a browser of an electronic device, the method executable at the electronic device, the method comprising:
storing in a local memory a static component associated with the web resource, the static component for rendering a static portion of the web resource in the browser;
establishing a permanent connection via a communication network with a server, the permanent connection enabling transmission of data using at least two data transfer protocols comprising HTTP-protocol and WebSocket protocol;
receiving from the server via the permanent connection a dynamic component for the web resource, the dynamic component for rendering a dynamic portion of the web resource in the browser;
combining the static component and the dynamic component to render the web resource in the browser; and
displaying to the user the web resource in the browser.

2. The method of claim 1, the server being a first server, the method further comprising, prior to said storing in a local memory the static component associated with the web resource, receiving the static component from a second server.

3. The method of claim 2, wherein the first server and the second server are executed in a single server.

4. The method of claim 2, wherein said receiving the static component is executed at a first download of the web resource to the electronic device.

5. The method of claim 2, wherein said receiving the dynamic component is executed during the first download of the web resource.

6. The method of claim 1, further comprising determining a staleness state of the static component.

7. The method of claim 6, said determining the staleness state of the static component comprises:
sending a query to the server that requests a latest date and time stamp associated with the static component;
receiving, from the server, the latest date and time stamp in response to the query, the latest date and time stamp indicating a most recent version of the static component of the web resource; and
comparing the latest date and time stamp of the first version of the static component and a current version of the static component.

8. The method of claim 7, further comprising, responsive to the latest date and time stamp of the first version of the static component not matching the date and time stamp of the current static component, receiving a second static component representative of the most recent version of the static component of the web resource.

9. The method of claim 8, further comprising replacing the first version of the static component with the second static component to display an updated version of the web resource in the browser.

10. The method of claim 1, further comprising determining a staleness state of the dynamic component.

11. The method of claim 10, wherein said determining the staleness state of the dynamic component comprises:
sending a query a second server that requests a latest date and time stamp associated with the dynamic component;
receiving, from the second server, the latest date and time stamp in response to the query, the latest date and time stamp indicating a most recent version of the dynamic component of the web resource; and
comparing the latest date and time stamp of a first version of the dynamic component and a current version of the dynamic component.

12. The method of claim 11, further comprising, responsive to the latest date and time stamp of the first version of the dynamic component not matching the date and time stamp of the most recent version of the dynamic component of the web resource, receiving the most recent version of the dynamic component of the web resource, the most recent version of the dynamic component of the web resource being a second dynamic component.

13. The method of claim 12, wherein said determining the staleness state of the first version of the dynamic component is effected on the server side, and wherein receiving the most recent version of the dynamic component of the web resource, the most recent version of the dynamic component of the web resource being a second dynamic component, is effected without the electronic device requesting the server for the most recent version of the dynamic component of the web resource.

14. The method of claim 12, further comprising replacing the first version of the dynamic component with the second dynamic component to display an updated version of the web resource in the browser on a periodic basis.

15. The method of claim 1, wherein at least one of the static component and the dynamic component are encoded in a respective native machine language.

16. The method of claim 13, further comprising translating of at least one of the static component and the dynamic component into an HTML code.

17. The method of claim 15, wherein said translating is executed locally on the electronic device.

18. The method of claim 1, wherein said permanent connection supports transmission of data through at least two communication channels.

20. The method of claim 1, a last version of the static component being a version of the static component having the most recent date and time stamp, a last version of the dynamic component being a version of the dynamic component having the most recent date and time stamp, the method further comprising combining the last version of the static component and the last version of the dynamic component to render the web resource in the browser on a periodic basis.

21. An electronic device comprising a display screen, a computer usable information storage medium, a processor coupled to the display screen and to computer usable information storage medium, the processor being configured to have access to computer readable commands which commands, when executed, cause the processor to:
store in a local memory a static component associated with the web resource, the static component for rendering a static portion of the web resource in the browser;
establish a permanent connection via a communication network with a server, the permanent connection enabling transmission of data using at least two data transfer protocols comprising HTTP-protocol and WebSocket protocol;
receive from the server via the permanent connection a dynamic component for the web resource, the dynamic component for rendering a dynamic portion of the web resource in the browser;
combine the static component and the dynamic component to render the web resource in the browser; and
display to the user the web resource in the browser.

22-40. (canceled)
